(19) United States
(12) Patent Application Publication
(10) Pub. No.: US 2019/0394347 A1
(43) Pub. Date: Dec. 26, 2019

(54) PROTECTED ELECTRONIC COMMUNICATION

(71) Applicants: Jian-Qun ZHANG, Shanghai (CN); Fei ZHANG, Shanghai (CN); Zhen YANG, Shanghai 2 (CN); Hewlett-Packard Development Company, L.P., Spring, TX (US)

(72) Inventors: Jian-Qun Zhang, Shanghai (CN); Fei Zhang, Shanghai (CN); Zhen Yang, Shanghai (CN)

(21) Appl. No.: 16/481,359

(22) PCT Filed: Feb. 15, 2017
(86) PCT No.: PCT/CN2017/073591

§ 371 Date: Jul. 26, 2019

(51) Int. Cl. H04N 1/00; H04N 1/32

(52) U.S. Cl. CPC H04N 1/00875; H04N 1/0084; H04L 51/22; H04N 1/32016; H04N 1/32026

(57) ABSTRACT

Examples disclosed herein relate to a protected electronic communication method comprising assigning a protected electronic communication to a data element, wherein the protected electronic communication comprises a plurality of identifier segments, receiving a request for the data element to be included in an analytics report, determining, according to the protected electronic communication, whether the data element is permitted to be included in the analytics report, and in response to determining that the data element is permitted to be included in the analytics report, providing the data element for use in the analytics report.

### BACKGROUND

In some situations, electronic communications, such as faxes or emails, may be received by devices that normally operate to print such communications. For example, a typical fax machine answers a call, receives the data of an electronic communication, and outputs it via printing capabilities such as a coupled ink or laser printer and paper supply. Recipients may then pick up the printed copy of the communications.

### BRIEF DESCRIPTION OF THE DRAWINGS

In the accompanying drawings, like numerals refer to like components or blocks. The following detailed description references the drawings, wherein:

FIG. 1 is a block diagram of a protected electronic communication device;

FIG. 2 is a flowchart of an example of a method for providing a protected electronic communication; and

FIG. 3 is a block diagram of an example system for providing a protected electronic communication.

### DETAILED DESCRIPTION

In some situations, a device, such as a printer, copier, fax machine, multifunction device, and/or the like, may receive electronic communications from a variety of users and/or sources. For example, the device may receive faxes from any fax number connected to a telephone network, may receive emails from computers and/or mobile devices, and/or may receive data from other devices such as logs from monitoring or manufacturing devices. In each of these and other examples, recipients of some communications may desire more security than others. In such cases, a source of the communication may be identified to determine whether the electronic communication should be subject to additional protection.

For example, a fax may be received from a financial institution that is intended for user A. In conventional systems, a fax machine would simply print out the received electronic communication regardless of the source or content. User A, however, may prefer that the electronic communication be protected from other users who may, inadvertently or intentionally, see and/or take the electronic communication. User A may therefore add the source of the communication—in this example, the financial institution's outgoing fax number—as protected. When the fax machine receives an electronic communication from a protected number, it may, instead of immediately outputting the communication to a printer, store the electronic communication in memory. The communication may, in some implementations, also be encrypted for additional security. The communication may be stored in memory until released by the user, such as by entering authentication information into the device. Such authentication information may, for example, comprise a password, PIN, ID card, biometric data, etc. In some implementations, the user's mobile device may serve to authenticate the user, such as by displaying a machine-readable code on a smartphone app that may be read by the device and/or by proximity detection of the mobile device, such as by BlueTooth or other wireless communication methods.

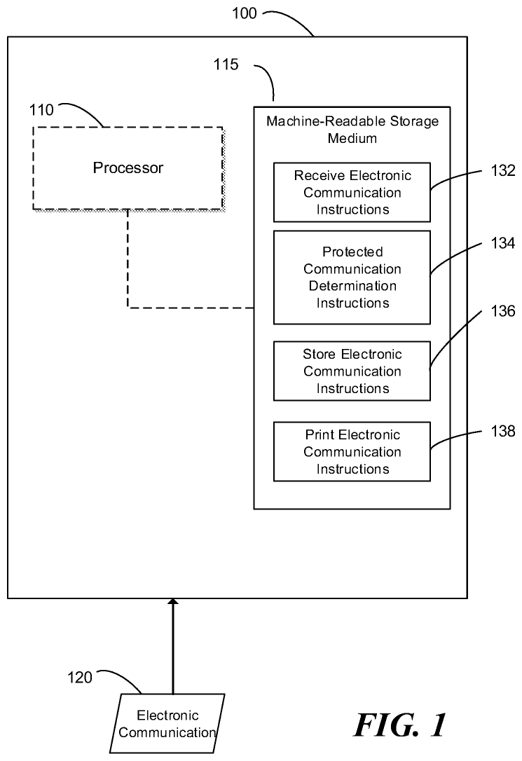

FIG. 1 is a block diagram of an example computing device 100 for providing a protected electronic communication such as protected electronic communication 105. Computing device 100 may comprise a processor 110 and a memory 115 comprising a non-transitory, machine-readable storage medium. Memory 115 may comprise a plurality of processor-executable instructions, such as receive electronic communication instructions 132, protected communication determination instructions 134, store electronic communication instructions 136, and print electronic communication instructions 138. In some implementations, instructions 132, 134, 136, 138 may be associated with a single computing device 100 and/or may be communicatively coupled among different computing devices such as via a direct connection, bus, or network.

Processor 110 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 115. In particular, processor 110 may fetch, decode, and execute instructions 132, 134, 136, 138.

Executable instructions 132, 134, 136, 138 may comprise logic stored in any portion and/or component of machine-readable storage medium 115 and executable by processor 110. The machine-readable storage medium 115 may comprise both volatile and/or nonvolatile memory and data storage components. Volatile components are those that do not retain data values upon loss of power. Nonvolatile components are those that retain data upon a loss of power.

The machine-readable storage medium 115 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Receive electronic communication instructions 132 may receive an electronic communication 120, such as an email, facsimile transmission (“fax”), print job, program, telephonic communication, voicemail, and/or other electronically transmitted information. For example, the electronic communication 120 may be transmitted via a network, telephone line, cellular, Bluetooth, and/or other communication medium and received by computing device 100. An application and/or service operating on computing device 100 may collect the data associated with the electronic communication 120 for further processing.

Protected communication determination instructions 134 may determine whether the electronic communication 120 comprises a protected communication, such as by determining whether an identified addressed recipient is associated with a protected recipient list. Protected communication determination instructions 134 may, for example, comprise instructions to determine whether a sender and/or recipient of electronic communication 120 is associated with a respective protected sender and/or protected recipient list. For example, a source phone number associated with a facsimile transmission and/or a sender of an email may be associated with a protected source list. The protected source list may, for example, be created and/or received from a user and/or an administrator of computing device 100. The user and/or administrator may enter sources, such as email addresses, phone numbers, and/or IP or other network addresses via a user interface displayed by computing device 100 and/or via another interface such as a web page, software application, and/or a control panel. In some implementations, a list may be created at a first computing device and distributed to a plurality of other computing devices, such as computing device 100. In some implementations, the protected source list may be associated a particular user and may only be applied to electronic communications received for that user. In other implementations, the protected source list may be shared among a plurality of recipient users and/or may be applied regardless of the recipient of the electronic communication 120.

In some implementations, protected communication determination instructions 134 may determine whether the electronic communication 120 is intended for a particular user as a recipient and/or received from a particular user as a sender. Instructions 134 may, for example, map a receiving phone number for a received fax communication to a particular recipient user, such as by using a corporate address book and/or other database. In some implementations, the electronic communication 120 may be scanned for recipient information, such as by performing textual analysis and/or optical character recognition (OCR) on the electronic communication 120 to identify a labeled recipient and/or recipients.

Store electronic communication instructions 136 may, in response to determining that the electronic communication 120 comprises a protected communication, store the electronic communication in memory 115. For example, portion(s) of memory 115 may be allocated for storing protected electronic communications. In some implementations, this memory may be non-volatile, so as to preserve the electronic communications in case of power loss to device 100.

In some implementations, store electronic communication instructions 136 may comprise instructions to notify the associated user of the receipt of the electronic communication. For example, an intended recipient of the electronic communication 120 may be identified according to an addressed recipient of the electronic communication 120, such as identifying a phone number at which a fax based electronic communication is received and looking up a user associated with that phone number. The user may be notified, for example, by means of an email, SMS/text message, SNMP alert, via an application configured to receive and display the notification, and/or other notification mechanisms.

In some implementations, store electronic communication instructions 136 may comprise instructions to encrypt the stored electronic communication. For example, a public key associated with a recipient user for the electronic communication may be used to encrypt electronic communication 120. In some implementations, the encryption may not be user specific, such as by using an encryption key associated with device 100 itself and/or a message receiving service/application to encrypt protected electronic communications associated with multiple recipient users. The decryption of the stored electronic communication may occur, for example, upon receiving a print/release authorization from a recipient user, such as by entering a PIN and/or password at device 100 and/or a printing device.

Print electronic communication instructions 138 may, in response to determining that the electronic communication does not comprise a protected communication, print the electronic communication. In some implementations, computing device 100 may comprise a printing device and/or a computer communicatively coupled to a printing device (not shown). Print electronic communication instructions 138 may, in some implementations, cause a stored and/or encrypted electronic communication to be printed after receiving a release authorization from a user, such as the recipient user.

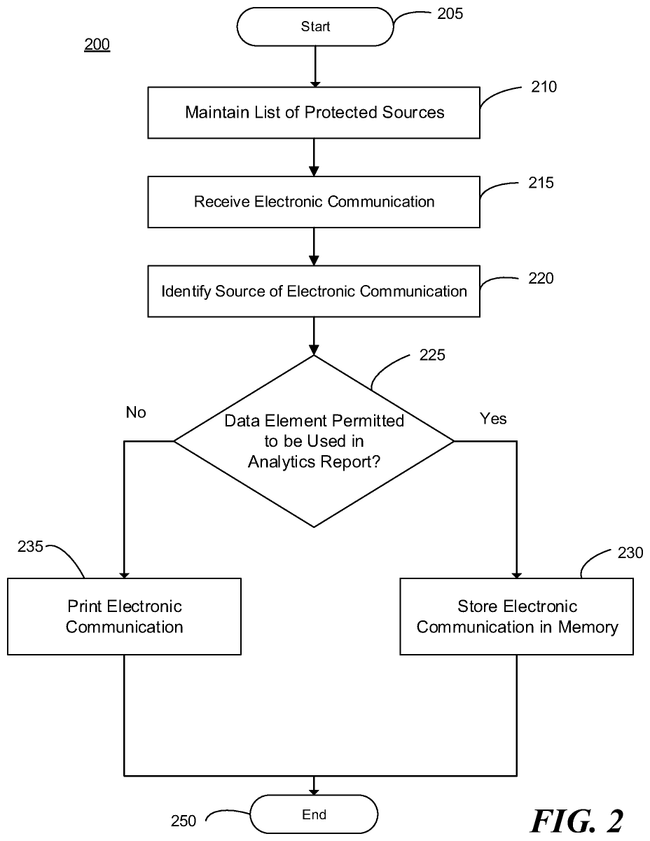

FIG. 2 is a flowchart of an example method 200 for providing document element re-positioning consistent with disclosed implementations. Although execution of method 200 is described below with reference to computing device 200, other suitable components for execution of method 200 may be used.

Method 200 may begin in stage 205 and proceed to stage 210 where computing device 100 may maintain a list of protected sources. For example, a source phone number associated with a facsimile transmission and/or a sender of an email may be associated with a protected source list. The protected source list may, for example, be created and/or received from a user and/or an administrator of computing device 100. The user and/or administrator may enter sources, such as email addresses, phone numbers, and/or IP or other network addresses via a user interface displayed by computing device 100 and/or via another interface such as a web page, software application, and/or a control panel. In some implementations, a list may be created at a first computing device and distributed to a plurality of other computing devices, such as computing device 100. In some implementations, the protected source list may be associated a particular user and may only be applied to electronic communications received for that user. In other implementations, the protected source list may be shared among a plurality of recipient users and/or may be applied regardless of the recipient of the electronic communication 120.

Method 200 may then advance to stage 215 where computing device 100 may receive an electronic communication. For example, receive electronic communication instructions 132 may receive an electronic communication 120, such as an email, facsimile transmission (“fax”), print job, program, telephonic communication, voicemail, and/or other electronically transmitted information. For example, the electronic communication 120 may be transmitted via a network, telephone line, cellular, Bluetooth, and/or other communication medium and received by computing device 100. An application and/or service operating on computing device 100 may collect the data associated with the electronic communication 120 for further processing.

Method 200 may then advance to stage 220 where computing device 100 may identify a source of the electronic communication. For example, the electronic communication may comprise a facsimile transmission (“fax”) and a source of the electronic transmission may comprises a phone number associated with a sender of the fax. Similarly, an email communication source may be identified by a sending email address.

Method 200 may then advance to stage 225 where computing device 100 may determining whether the electronic communication comprises a protected communication by determining whether the list of protected sources comprises the source of the electronic communication. For example, protected communication determination instructions 134 may determine whether the electronic communication 120 comprises a protected communication, such as by determining whether an identified addressed recipient is associated with a protected recipient list. Protected communication determination instructions 134 may, for example, comprise instructions to determine whether a sender and/or recipient of electronic communication 120 is associated with a respective protected sender and/or protected recipient list. For example, a source phone number associated with a facsimile transmission and/or a sender of an email may be associated with a protected source list. The protected source list may, for example, be created and/or received from a user and/or an administrator of computing device 100. The user and/or administrator may enter sources, such as email addresses, phone numbers, and/or IP or other network addresses via a user interface displayed by computing device 100 and/or via another interface such as a web page, software application, and/or a control panel. In some implementations, a list may be created at a first computing device and distributed to a plurality of other computing devices, such as computing device 100. In some implementations, the protected source list may be associated a particular user and may only be applied to electronic communications received for that user. In other implementations, the protected source list may be shared among a plurality of recipient users and/or may be applied regardless of the recipient of the electronic communication 120.

In some implementations, protected communication determination instructions 134 may determine whether the electronic communication 120 is intended for a particular user as a recipient and/or received from a particular user as a sender. Instructions 134 may, for example, map a receiving phone number for a received fax communication to a particular recipient user, such as by using a corporate address book and/or other database. In some implementations, the electronic communication 120 may be scanned for recipient information, such as by performing textual analysis and/or optical character recognition (OCR) on the electronic communication 120 to identify a labeled recipient and/or recipients.

In response to determining that the electronic communication comprises a protected communication, method 200 may then advance to stage 230 where computing device 100 may store the electronic communication in memory. In some implementations, storing the electronic communication in memory may comprise encrypting the stored electronic communication, such as by encrypting the stored electronic communication according to an encryption key associated with an intended recipient of the stored electronic communication.

For example, store electronic communication instructions 136 may, in response to determining that the electronic communication 120 comprises a protected communication, store the electronic communication in memory 115. For example, portion(s) of memory 115 may be allocated for storing protected electronic communications. In some implementations, this memory may be non-volatile, so as to preserve the electronic communications in case of power loss to device 100.

In some implementations, store electronic communication instructions 136 may comprise instructions to encrypt the stored electronic communication. For example, a public key associated with a recipient user for the electronic communication may be used to encrypt electronic communication 120. In some implementations, the encryption may not be user specific, such as by using an encryption key associated with device 100 itself and/or a message receiving service/application to encrypt protected electronic communications associated with multiple recipient users. The decryption of the stored electronic communication may occur, for example, upon receiving a print/release authorization from a recipient user, such as by entering a PIN and/or password at device 100 and/or a printing device.

In some implementations, store electronic communication instructions 136 may comprise instructions to notify the associated user of the receipt of the electronic communication. For example, an intended recipient of the electronic communication 120 may be identified according to an addressed recipient of the electronic communication 120, such as identifying a phone number at which a fax based electronic communication is received and looking up a user associated with that phone number. The user may be notified, for example, by means of an email, SMS/text message, SNMP alert, via an application configured to receive and display the notification, and/or other notification mechanisms.

In response to determining that the electronic communication does not comprise a protected communication, method 200 may then advance to stage 235 where computing device 100 may print the electronic communication. For example, print electronic communication instructions 138 may, in response to determining that the electronic communication does not comprise a protected communication, print the electronic communication. In some implementations, computing device 100 may comprise a printing device and/or a computer communicatively coupled to a printing device (not shown). Print electronic communication instructions 138 may, in some implementations, cause a stored and/or encrypted electronic communication to be printed after receiving a release authorization from a user, such as the recipient user.

Method 200 may then end at stage 250.

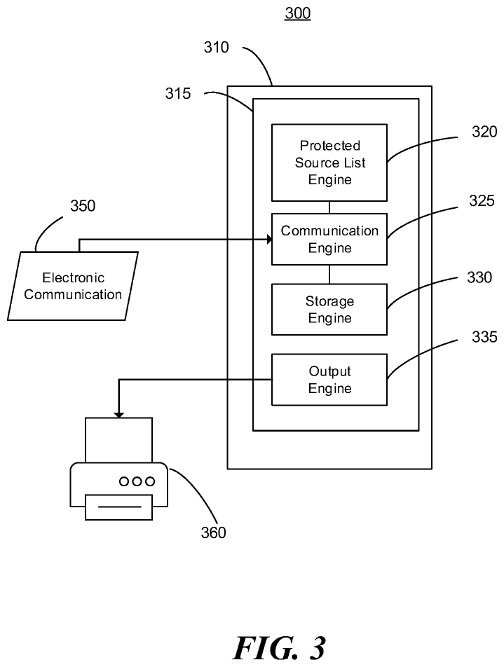

FIG. 3 is a block diagram of an example system 300 for providing a protected electronic communication. System 300 may comprise a computing device 310 comprising a memory 315. Computing device 310 may comprise, for example, a general and/or special purpose computer, server, mainframe, desktop, laptop, tablet, smart phone, game console, printer and/or any other system capable of providing computing capability consistent with providing the implementations described herein. Computing device 310 may store, in memory 315, a protected source list engine 320, a communication engine 325, a storage engine 330, and an output engine 335.

Protected source list engine 320 may receive a plurality of protected source identifiers, and maintain the plurality of protected source identifiers. For example, a source phone number associated with a facsimile transmission and/or a sender of an email may be associated with a protected source list. The protected source list may, for example, be created and/or received from a user and/or an administrator of computing device 310. The user and/or administrator may enter sources, such as email addresses, phone numbers, and/or IP or other network addresses via a user interface displayed by computing device 310 and/or via another interface such as a web page, software application, and/or a control panel. In some implementations, a list may be created at a first computing device and distributed to a plurality of other computing devices, such as computing device 100. In some implementations, the protected source list may be associated a particular user and may only be applied to electronic communications received for that user. In other implementations, the protected source list may be shared among a plurality of recipient users and/or may be applied regardless of the recipient of an electronic communication 350.

Communication engine 325 may receive an electronic communication, identify a source of the electronic communication, and determine whether the electronic communication comprises a protected communication according to the source of the electronic communication. For example, receive electronic communication instructions 132 may receive electronic communication 350, such as an email, facsimile transmission (“fax”), print job, program, telephonic communication, voicemail, and/or other electronically transmitted information. For example, the electronic communication 350 may be transmitted via a network, telephone line, cellular, Bluetooth, and/or other communication medium and received by computing device 310. An application and/or service operating on computing device 310 may collect the data associated with the electronic communication 350 for further processing.

Protected communication determination instructions 134 may determine whether the electronic communication 350 comprises a protected communication, such as by determining whether an identified addressed recipient is associated with a protected recipient list. Protected communication determination instructions 134 may, for example, comprise instructions to determine whether a sender and/or recipient of electronic communication 350 is associated with a respective protected sender and/or protected recipient list.

In some implementations, protected communication determination instructions 134 may determine whether the electronic communication 350 is intended for a particular user as a recipient and/or received from a particular user as a sender. Instructions 134 may, for example, map a receiving phone number for a received fax communication to a particular recipient user, such as by using a corporate address book and/or other database. In some implementations, the electronic communication 350 may be scanned for recipient information, such as by performing textual analysis and/or optical character recognition (OCR) on the electronic communication 350 to identify a labeled recipient and/or recipients.

Storage engine 330 may, in response to determining that the electronic communication comprises a protected communication, encrypt the electronic communication, and store the electronic communication in a memory. For example, store electronic communication instructions 136 may, in response to determining that the electronic communication 350 comprises a protected communication, store the electronic communication in memory 315. For example, portion(s) of memory 315 may be allocated for storing protected electronic communications. In some implementations, this memory may be non-volatile, so as to preserve the electronic communications in case of power loss to device 310.

In some implementations, store electronic communication instructions 136 may comprise instructions to notify the associated user of the receipt of the electronic communication. For example, an intended recipient of the electronic communication 350 may be identified according to an addressed recipient of the electronic communication 350, such as identifying a phone number at which a fax based electronic communication is received and looking up a user associated with that phone number. The user may be notified, for example, by means of an email, SMS/text message, SNMP alert, via an application configured to receive and display the notification, and/or other notification mechanisms.

In some implementations, store electronic communication instructions 136 may comprise instructions to encrypt the stored electronic communication. For example, a public key associated with a recipient user for the electronic communication may be used to encrypt electronic communication 120. In some implementations, the encryption may not be user specific, such as by using an encryption key associated with device 310 itself and/or a message receiving service/application to encrypt protected electronic communications associated with multiple recipient users. The decryption of the stored electronic communication may occur, for example, upon receiving a print/release authorization from a recipient user, such as by entering a PIN and/or password at device 310 and/or a printing device.

Output engine 335 may print the electronic communication. For example, output engine 335 may print electronic communication 350 on a printing device 360 in response to determining that electronic communication 350 does not comprise a protected communication. In some implementations, output engine 335 may print electronic communication 350 on printing device 360 in response to receiving a release authorization from a recipient of electronic communication 250. In some implementations, print electronic communication instructions 138 may, in response to determining that the electronic communication does not comprise a protected communication, print the electronic communication. In some implementations, computing device 310 may comprise a printing device and/or a computer communicatively coupled to a printing device 360. Print electronic communication instructions 138 may, in some implementations, cause a stored and/or encrypted electronic communication to be printed after receiving a release authorization from a user, such as the recipient user.

Although one computing device 310 is depicted in FIG. 3, certain implementations of system 300 may comprise more than one computing device 310. At least one of the computing devices may be employed and arranged, for example, in at least one server bank, computer bank, data center, and/or other arrangements. For example, the computing devices together may include a cloud computing resource, a grid computing resource, and/or any other distributed computing arrangement. Such computing devices may be located in a single installation and/or may be distributed among many different geographical locations.

The disclosed examples may include systems, devices, computer-readable storage media, and methods for document element re-positioning. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

What is claimed is:

1. A non-transitory machine readable medium storing instructions executable by a processor to:
receive an electronic communication;
determine whether the electronic communication comprises a protected communication;
in response to determining that the electronic communication comprises a protected communication, store the electronic communication in a memory; and
in response to determining that the electronic communication does not comprise a protected communication, print the electronic communication.

2. The non-transitory machine readable medium of claim 1, wherein the electronic communication comprises a facsimile transmission.

3. The non-transitory machine readable medium of claim 2, wherein the instructions to determine whether the electronic communication comprises a protected communication further comprise instructions to determine whether a source phone number associated with the facsimile transmission is associated with a protected source list.

4. The non-transitory machine readable medium of claim 1, wherein the protected source is received by a user.

5. The non-transitory machine readable medium of claim 4, wherein the stored electronic communication is associated with the user.

6. The non-transitory machine readable medium of claim 5, wherein the instructions to store the electronic communication in memory further comprise instructions to notify the associated user of the receipt of the electronic communication.

7. The non-transitory machine readable medium of claim 1, wherein the instructions to store the electronic communication in memory comprise instructions to encrypt the stored electronic communication.

8. The non-transitory machine readable medium of claim 1, wherein the instructions to store the electronic communication in memory further comprise instructions to notify a recipient user of the receipt of the electronic communication.

9. The non-transitory machine readable medium of claim 8, wherein the instructions to notify the recipient user of the receipt of the electronic communication comprise instructions to identify an addressed recipient from the electronic communication.

10. The non-transitory machine readable medium of claim 9, wherein the instructions to determine whether the electronic communication comprises a protected communication further comprise instructions to determine whether the identified addressed recipient is associated with a protected recipient list.

11. A method comprising:
maintaining a list of protected sources;
receiving an electronic communication;
identifying a source of the electronic communication;
determining whether the electronic communication comprises a protected communication by determining whether the list of protected sources comprises the source of the electronic communication; and
in response to determining that the electronic communication comprises a protected communication, storing the electronic communication in memory; and
in response to determining that the electronic communication does not comprise a protected communication, printing the electronic communication.

12. The method of claim 11, wherein the electronic communication comprises a facsimile transmission and the source comprises a phone number associated with a sender of the facsimile transmission.

13. The method of claim 11, wherein storing the electronic communication in memory further comprises encrypting the stored electronic communication.

14. The method of claim 13, wherein encrypting the stored electronic communication comprises encrypting the stored electronic communication according to an encryption key associated with an intended recipient of the stored electronic communication.

15. A system, comprising:
a protected source list engine to:
receive a plurality of protected source identifiers, and
maintain the plurality of protected source identifiers;
a communication engine to:
receive an electronic communication,
identify a source of the electronic communication, and
determine whether the electronic communication comprises a protected communication according to the source of the electronic communication;
a storage engine to:
in response to determining that the electronic communication comprises a protected communication:
encrypt the electronic communication, and
store the electronic communication in a memory; and
an output engine to:
in response to determining that the electronic communication does not comprise a protected communication, print the electronic communication.
